(19) United States
(12) Patent Application Publication
(10) Pub. No.: US 2016/0250781 A1
(43) Pub. Date: Sep. 1, 2016

(54) PANEL ASSEMBLY AND METHOD OF FORMING THE SAME

(71) Applicant: FORD GLOBAL TECHNOLOGIES, LLC, Dearborn, MI (US)

(72) Inventors: Wei XU, Nanjing (CN); Xingxing ZHOU, Nanjing (CN)

(21) Appl. No.: 15/054,575

(22) Filed: Feb. 26, 2016

(30) Foreign Application Priority Data
Feb. 28, 2015 (CN) 2015 100 922 67.2

(51) Int. Cl. B29C 43/18; B60J 1/20

(52) U.S. Cl. CPC B29C 43/18; B60J 1/2094; B29K 2023/12

(57) ABSTRACT

A method of forming a panel assembly from a including a through-aperture defining head and tail edges along a thickness direction, may include contacting at least a portion of the tail edge with a polymer, moving a volume of the polymer toward the head edge within the through-aperture, and heating the volume of the polymer to form the panel assembly.

### CROSS-REFERENCE TO RELATED APPLICATIONS

This application claims foreign priority benefits under 35 U.S.C. §119(a)-(d) to CN 2015 100 922 67.2 filed Feb. 28, 2015, which is hereby incorporated by reference in its entirety.

### TECHNICAL FIELD

The present disclosure relates to a panel assembly and a method of forming the same.

### BACKGROUND

In consideration for vehicle interior functionality, rear window decorative panels may be provided between a vehicle rear seat and a vehicle trunk. The rear window decorative panels may often be formed of glass fibers reinforced polypropylene (PP) composite materials for cost efficiencies.

In certain existing designs, a number of breather holes may be formed by directly punching on the decorative panel over a punching die during molding. However, the thus formed decorative panel may often be over-stretched during the punching process, and accordingly unpleasant stress edge may result.

One solution in the industry may be to provide coverings over the breather holes on the decorative panel to cover the stress edges together with the holes.

### SUMMARY

The present disclosure is to provide a panel assembly and a method of forming the same in a cost effective way.

In one or more embodiments, the present disclosure provides a method of forming a panel assembly from a panel, the panel including a through-aperture defining head and tail edges along a thickness direction, where the method includes contacting at least a portion of the tail edge with a polymer, moving a volume of the polymer toward the head edge within the through-aperture, and heating the volume of the polymer to form the panel assembly.

In another or more embodiments, the present disclosure provides a panel assembly, where the panel assembly includes a panel with a through-aperture defining first head and first tail edges along a thickness direction, and a thermoset polymer contacting the first tail edge.

In another embodiment, the panel assembly may include a panel defining an aperture having a tail head and a tail edge; and a polymer arranged adjacent the tail edge such that the polymer is applied to the panel and at least a portion thereof is received within the aperture to provide an edge cover for the aperture.

One or more advantageous features as described herein are believed to be readily apparent from the following detailed description of one or more embodiments when taken in connection with the accompanying drawings.

### BRIEF DESCRIPTION OF THE DRAWINGS

FIG. 1A illustratively depicts a view of a polymer on a panel in preparation for forming a panel assembly according to one or more embodiments of the present disclosure;

FIG. 1B is an alternative illustration of the arrangement referenced in FIG. 1A;

FIG. 2 illustratively depicts another view of the panel assembly formed from the panel and the polymer referenced in FIG. 1A or FIG. 1B;

FIG. 3 illustratively depicts a process flowchart for forming the panel assembly referenced in FIG. 2;

FIG. 4A illustratively depicts a view of the panel assembly formed according to the process referenced in FIG. 3; and

FIGURE. 4B illustratively depicts a cross-sectional view of the panel assembly referenced in FIG. 4A.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

One or more embodiments of the present invention are described herein with details; however, it is appreciated that much of the detailed description is provided as illustrative examples and may be varied as suitable. The drawings referenced herein are schematic and associated views thereof are not necessarily drawn to scale, where certain features may be enlarged or minimized to show details. Particular structures and functional details as referenced in the detailed description are not meant to be limiting and rather form the representative basis upon which variations may be realized in carrying out the present invention.

A method of forming a panel assembly from a panel may be disclosed herein, the panel including a through-aperture defining head and tail edges along a thickness direction, where the method includes contacting at least a portion of the tail edge with a polymer, moving a volume of the polymer toward the head edge within the through-aperture, and heating the volume of the polymer to form the panel assembly. As is detailed herein elsewhere, the method is believed to provide in a cost effective way a method of forming a visually appealing panel assembly from a panel by concealing with a polymer any stress edges associated with the formation of through-apertures for instance via punching. The method in particular is to provide visual enhancement by reducing certain edge imperfections such as white streaks around the edges of a punched through-aperture on the panel.

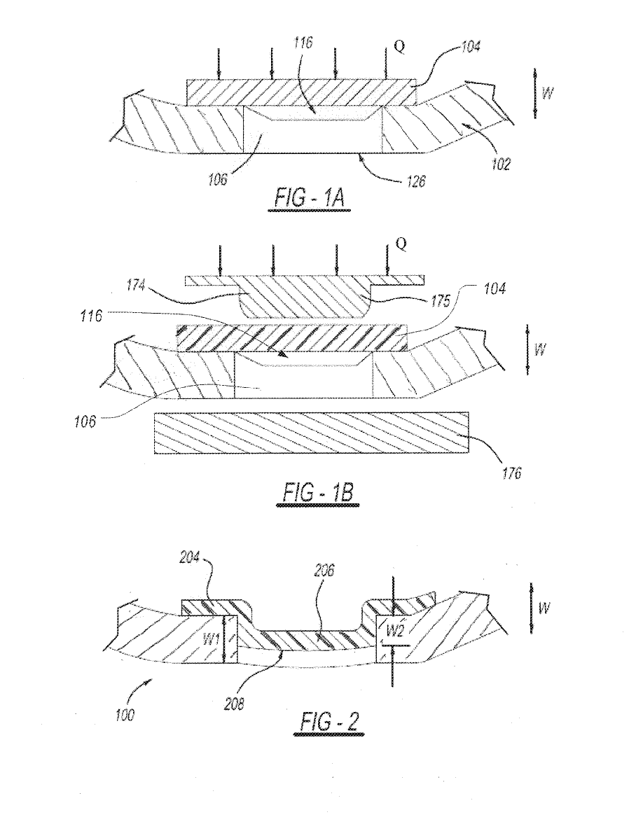

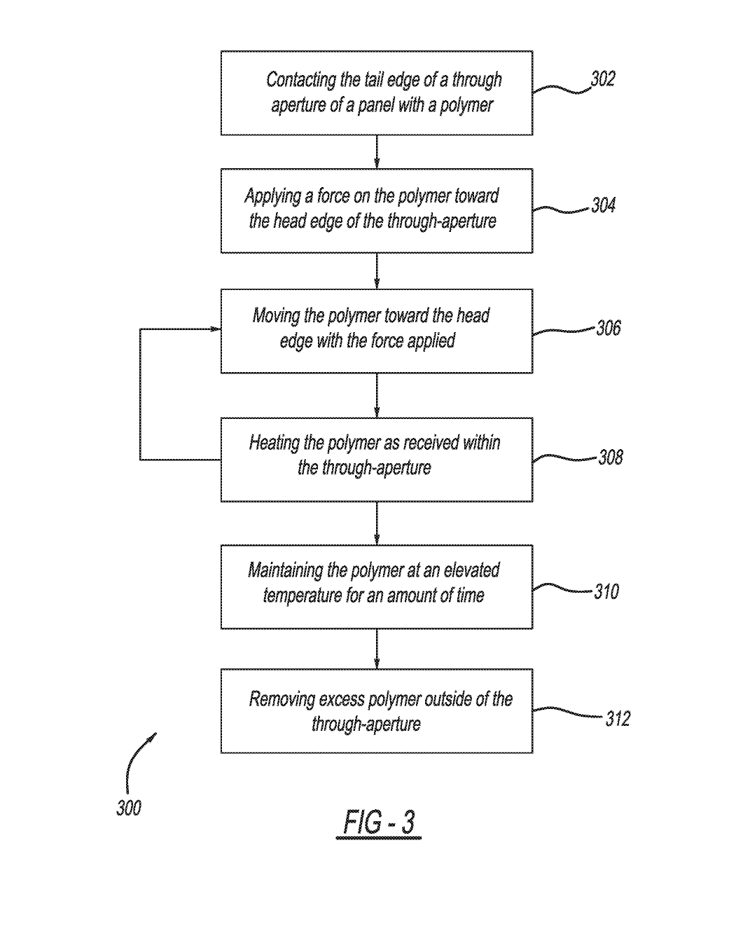

As illustratively depicted in FIG. 1 through FIG. 4, a method generally shown at 300 referenced in FIG. 3 is provided for forming a panel assembly 100 from a panel 102, where aperture edge issues associated with the formation of an aperture may be readily reduced in a cost effective way.

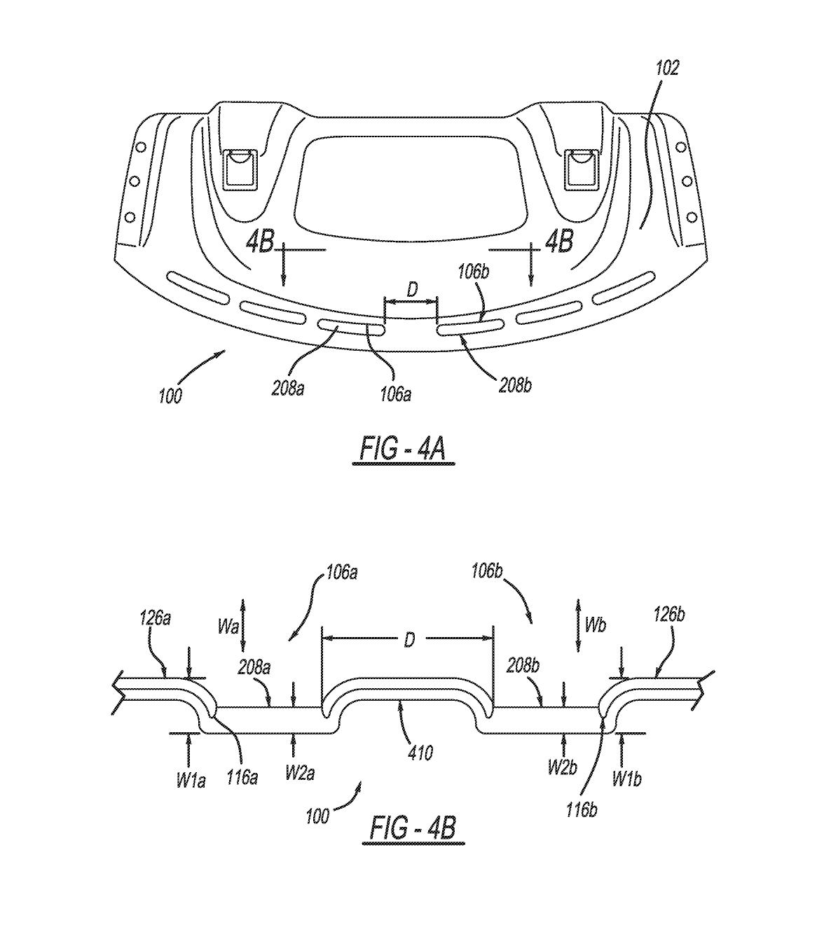

According to one or more embodiments of the present disclosure, FIG. 1A illustratively depicts a polymer 104 being positioned on the panel 102 and ready to be pressed into a through-aperture 106 defined on the panel 102. Further in view of step 302 referenced in the method 300 of FIG. 3, the through-aperture 106 of the panel 102 includes a head edge 126 and a tail edge 116 positioned along a thickness direction “W”. As illustratively depicted in FIG. 4A, more than one through-aperture 106 may be defined on the panel 102 for any suitable structural and/or mechanical benefits. By way of example, one or more through-apertures 106 may be employed for air ventilation between compartments separated by the panel assembly 100.

Referring back to FIG. 1A, and in view of step 302 and step 304 of FIG. 3, at least a portion of the tail edge 116 of the through-aperture 106 is contacted with the polymer 104. A force “Q” may be applied to the polymer 104 to assist with its movement from the tail edge 116 to the head edge 126. The force “Q” may be supplied by any suitable source and method of delivery. By way of example, the force “Q” may be delivered by direct contact of an operator's hand and/or any suitable tools to assist with the press-in of the polymer 104 into the through-aperture 106.

In certain embodiments, and as illustratively depicted in FIG. 1B, the force “Q” may delivered by any suitable machinery such as a punching die assembly. In particular, the panel 102 and the polymer 104 may be positioned between punching die parts. The punching die assembly includes a first die part 174 and a second die part 176, where the first die part 174 includes a die protrusion 175 with shape complementary to the through-aperture 106 and in particular an entry circumferential shape of the tail edge 116.

Referring back to step 304, the polymer 104 along with the panel 102 is positioned between the first die part 174 and the second die part 176 such that the predetermined force “Q” may be applied to the polymer 104 on the panel 102 via the die protrusion 175 of the first die part 174 along the thickness direction “W”, for instance, a direction from the tail edge 116 toward the head edge 126. In one or more embodiments of the present disclosure, the thickness direction referenced in FIG. 2 is a direction of gravity. The thickness direction “W” may be a direction of gravity plus or minus up to 15 degrees. Furthermore, the thickness direction may be varied with any suitable arrangement of the panel 102 and the punching die assembly.

At step 306 and in view of FIG. 2, a volume of polymer 104 is moved toward the head edge 126 and into the through-aperture 106. Further in view of FIG. 1B, the moving may be carried out by subjecting the volume of polymer 104 to be positioned between the first and second die parts 174, 176. In particular, under the predetermined force “Q” applied via the die protrusion 175, the volume of the polymer 104 is to travel toward the head edge 126 of the through-aperture 106 for a distance to form a polymer protrusion 206 as positioned within the through-aperture 106. In one or more embodiments, the volume of the polymer 104 is substantially equal to the volume of the polymer protrusion 206, optionally with no more than 15% in volume difference there-between.

As mentioned herein elsewhere, the size of the die protrusion 175 corresponds to that of the through-aperture 106. In certain embodiments, the die protrusion 175 is sized to be smaller than the through-aperture 106. Accordingly, an outer peripheral edge of the die protrusion 175 may be spaced apart from an inner peripheral edge of the through-aperture 106 with a distance for instance, but not limited to, 3 millimeters (mm) to 8 mm, so as to avoid unintended severance of the polymer protrusion 206 via a die punching.

The polymer protrusion 206 of the polymer 104 referenced in FIG. 2 is of a thickness “W2” along the thickness direction “W”, which is a direction from the tail edge 116 toward the head surface 208, and the through-aperture 106 is of a thickness “W1” in a direction from the tail edge 116 toward the head edge 126. The thickness “W2” of the polymer projection 206 is smaller than or equal to the thickness “W1” of the through-aperture 106, and in certain embodiments is no greater than 75 percent (%) or 50% and no less than 5% or 10%. Accordingly, the volume of the polymer 104 travels along the thickness direction “W” for a distance that is no greater than the thickness “W1” of the through-aperture 106. Optionally, the moving may be carried out such that the volume of the polymer 104 travels along the thickness direction “W” with a distance greater than or equal to the thickness “W1” of the through-aperture 106 such that, for instance, a head surface 208 protrudes out of the head edge 126.

At step 308, the volume of the polymer 104 as received within the through-aperture 106 is heated to form the panel assembly 100. In certain embodiments, the volume of the polymer 104 may still be a polymer in nature before or after the heating, however spacing or gap distances between molecules of the polymer may change. Without wanting to be limited to any particular theory, it is believed the polymer 104 may become thermoset with the heat applied and therefore forms a stable plug at least around the tail edge 116. Accordingly, any undesirable edge defects such as white streaks present or around the tail edge 116 may be comfortably and stably masked via the polymer 104 that becomes thermoset.

The heating may be carried out by any suitable methods. By way of example, a portable heater may be positioned close to where the polymer 104 is located and heat is then imparted to assist with the thermoset formation of the polymer 104. Alternatively, the die protrusion 175 may also be electrically conductive to deliver the heat needed for the thermoset formation. This configuration may be particular useful where the movement of the polymer 104 within the through-aperture 106 and the heating of the same may be concurrently or sequentially carried out via the same equipment, here the die parts 174, 176.

Although in one or more embodiments the moving at step 306 and the heating at step 308 are carried out separately, in other embodiments the moving and the heating may be carried with an overlap in time. By way of example, the volume of the polymer 104 may be moved in separate batches toward the head edge 126. The heating may be initiated soon after each batch of the polymer 104 is moved into its predetermined position within the through-aperture 106 along the direction “W”. Accordingly, the movement of the next batch of the polymer 104 may in effect start before or after the previous batch is completed. In particular, it may be more advantageous for the polymer 104 to be thermoset at a predetermined temperature obtained with the heating for consideration of time and energy efficiencies, where the heating may be carried out during the moving step and the predetermined temperature is reached along with the formation of the polymer protrusion 206.

At step 310, the volume of the polymer 104 is maintained at an elevated temperature or a temperature higher than the room temperature. Furthermore, the heating is carried out for a predetermined amount of time. For instance, and when a thermoset polymer such as polyurethane is involved, the heating may be maintained at 120 degrees for 10 seconds to result in an eventual configuration of the polymer protrusion 206 via which stress edges of the through-aperture 106 may be effectively concealed. Accordingly, a visually appealing panel assembly 100 may be provided in a cost effective way.

At step 312, excess polymer material around the through-aperture 106 may be removed. Optionally, this step may be omitted as needed and when suitable. The removal may be particularly useful and even desirable when the panel assembly 100 may be used thereafter for downstream assembly with other structural components where the excess polymer material may hinder such downstream assembly. Alternatively and when the panel 102 itself includes two or more sub layers and the polymer 104 may be positioned between any two of these sublayers, removal of excess polymer material is helpful.

In this regard, the panel 102 may include an outer layer and an inner layer contacting the outer layer, where the outer layer material may differ from the inner layer in material, for instance, the outer layer material may include a black foam material to further reduce the impact of stress edges with the formation of the through-aperture 106. When provided as a polymer layer, the polymer 104 may be positioned between the inner layer and the outer layer or may be positioned such that the inner layer is positioned between the polymer 104 and the outer layer.

The panel 102 may be any suitable panel employed within a vehicle. In certain embodiments, the panel 102 may include a glass fiber. In particular, the panel 102 may include a polypropylene and glass fiber composite.

Referring back to FIG. 4A and in view of FIG. 4B, the panel assembly 100 for a vehicle is illustratively depicted as formed, where a volume of thermoset polymer 104 is received within a first through-aperture 106a extending from a first tail edge 116a and defines a head surface 208a, the head surface 208a being positioned between the first head and tail edges 126a, 116a of the through-aperture 106a. A volume of thermoset polymer 104 may also be received within a second through-aperture 106b extending form a second tail edge 116b and defines a head surface 208b, the head surface 208b being positioned between the second head and tail edges 126b, 116b of the through-aperture 106b. For instance, the second through-aperture 106b may be spaced apart from the first through-aperture 106a with a distance “D”. The first through-aperture 106a defines the first head and tail edges 126a, 116a along a first thickness direction “Wa.” The second through-aperture 106b defines the second head and tail edges 126b, 116b along a second thickness direction “Wb.”

A number of through-apertures 106 including 106a, 106b depicted in FIG. 4A and 4B may differ in shape and/or size. The punching die assembly in one or more embodiments may include a number of protrusions 175 corresponding to the number of the through-apertures 106 in shape and size. Referring back to FIG. 4B, for instance, the first through-aperture 106a defines a first thickness W1a and the second through-aperture 106b defines a second thickness W1b which may be the same to or different from the first thickness W1a. Furthermore, the second thickness direction Wb may be different from the first thickness direction Wa dependent upon any suitable structural arrangement of the panel 102. Accordingly, the thickness W2b of the polymer protrusion 206b of the polymer 104 received within the second through-aperture 106b may be varied with the thickness W1b of the second through-aperture 106b, where the W2b may be smaller than or equal to the W1b. Further, the thickness W2b of the polymer protrusion 206b positioned within the second through-aperture 106b may be different from the thickness W2a of the polymer protrusion 206a positioned within the first through-aperture 106a. The polymer 104 contacts the second tail edge 116.

The polymer 104 further includes a surface 410 of the panel 102 positioned between the first tail edge 116a and the second tail edge 116b. It is advantageous in that the polymer 104 may contact all at once various tail edges of the through-apertures 106 of the panel 102 to deliver additional benefits in assembly time and cost.

The polymer 104 may be provided as a polymer layer. Furthermore, the contacting step may be carried out to include attaching the polymer 104 as a polymer layer to the panel 102 for instance via glue and rivet and particularly at areas such as the surface 410 where connection or adhesion of the polymer 104 to the panel 102 may be relatively enhanced.

One or more embodiments described herein are illustrative and exemplary, and are not limiting. One skilled in the art may readily recognize various changes, modifications and variations that may be made herein without departing from the true spirit and fair scope of the present invention as defined by the following claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of forming a panel assembly from a panel, the panel including a through-aperture defining head and tail edges along a thickness direction, the method comprising:
contacting at least a portion of the tail edge with a polymer;
moving a volume of the polymer toward the head edge within the through-aperture; and
heating the volume of the polymer to form the panel assembly.

2. The method of claim 1, wherein the polymer is provided as a polymer layer.

3. The method of claim 1, wherein the moving is carried out by subjecting the volume of the polymer to be between first and second die parts.

4. The method of claim 1, wherein the moving is carried out such that the volume of the polymer travels for a distance no greater than a thickness of the through-aperture along the thickness direction.

5. The method of claim 1, wherein the heating is carried out for an amount of time.

6. The method of claim 1, wherein the moving and the heating overlap in time.

7. The method of claim 1, wherein the heating is initiated after the volume of the polymer is positioned between the head and tail edges.

8. The method of claim 1, wherein the heating includes subjecting the volume of the polymer to a predetermined temperature for a predetermined amount of time.

9. A panel assembly, comprising:
a panel with a first through-aperture defining first head and tail edges positioned along a thickness direction; and
a thermoset polymer contacting the first tail edge.

10. The panel assembly of claim 9, wherein a volume of the thermoset polymer is received within the first through-aperture extending from the first tail edge and defines a head surface, the head surface being positioned between the first head and tail edges of the first through-aperture.

11. The panel assembly of claim 9, wherein the panel further includes a second through-aperture spaced apart from the first through-aperture and defining second head and tail edges along a second thickness direction.

12. The panel assembly of claim 11, wherein the thermoset polymer contacts the second tail edge.

13. The panel assembly of claim 12, wherein the thermoset polymer further contacts a surface of the panel positioned between the first and second tail edges.

14. The panel assembly of claim 9, wherein the panel includes glass fibers.

15. The panel assembly of claim 9, wherein the panel includes an outer layer and an inner layer contacting the outer layer.

16. A panel assembly, comprising:
a panel defining an aperture having a tail head and a tail edge; and
a polymer arranged adjacent the tail edge such that the polymer is applied to the panel and at least a portion thereof is received within the aperture to provide an edge cover for the aperture.

17. The panel assembly of claim 16, wherein a volume of the polymer is received within the aperture extending from the tail edge and defines a head surface, the head surface being positioned between the head and tail edges of aperture.

18. The panel assembly of claim 17, wherein a thickness of the polymer received within the aperture does not exceed a thickness of the aperture.
